(19) United States
(12) Patent Application Publication
(10) Pub. No.: US 2023/0400192 A1
(43) Pub. Date: Dec. 14, 2023

(54) KITCHEN RANGE WITH INTERNAL CIRCULATION OIL FUME PURIFICATION

(71) Applicant: Shanghai Dohuan Oil-Smoke Cleaning Equipment Co., Ltd., Shanghai (CN)

(72) Inventors: Weibin HE, Shanghai (CN); Yang HE, Shanghai (CN); Bing HE, Shanghai (CN)

(21) Appl. No.: 17/956,286

(22) Filed: Sep. 29, 2022

(30) Foreign Application Priority Data
Jun. 13, 2022 (CN) 202210659973.0

(51) Int. Cl. F24C 15/20

(52) U.S. Cl. CPC F24C 15/2035

(57) ABSTRACT

Disclosed is a kitchen range with internal circulation oil fume purification, including a housing, a gas suction port, a gas suction channel, a blower device, a gas exhaust channel, a gas guide port, and a purification device. The housing is provided with a stovetop and a fume collecting hood extending outwards, and the stovetop is provided with a stove area. The gas suction port is provided on the lower surface of the fume collecting hood. The gas guide port is arranged on the stovetop, and has a multi-hole structure with multiple holes, wherein the holes are provided around a periphery of the stove area, and all the holes are inclined toward a same clockwise or anti-clockwise direction and have a same inclined angle with respect to the stovetop.

### CROSS REFERENCE TO RELATED APPLICATION

This patent application claims the benefit and priority of Chinese Patent Application No. 202210659973.0 filed on Jun. 13, 2022, the disclosure of which is incorporated by reference herein in its entirety as part of the present application.

### BACKGROUND

### Related Field

The present disclosure relates to a kitchen range with oil fume purification, and in particular relates to a kitchen range with internal circulation oil fume purification for indoor use.

### Related Art

With development of society and economy, a contradiction between people's demand for a better life and the unbearable gas pollution has become increasingly serious, especially an issue of external emission of oil fume gas in social catering and home cooking has been highly regarded by the society and government. Many developed countries in the world have explicitly banned the external emission of cooking oil fume gas. For addressing this contradiction, an internal circulation oil fume purification technology has also been presented in the prior art, which mainly purifies the oil fume gas produced in cooking by filtering and other means and then returns the purified gas into the room. However, the above technology has a disadvantage that the actual use efficiency is reduced with the saturation of the purification material or the technical limitation of the purification material itself, which may in turn cause a pollution of indoor space.

### BRIEF SUMMARY

In view of the above defects in the prior art, a technical problem to be solved by the present disclosure is to provide a kitchen range with internal circulation oil fume purification, which enables exhausted gas to entrain oil fume gas to reenter the same channel for recirculation.

To achieve the objective, the present disclosure provides a kitchen range with internal circulation oil fume purification, which includes a housing, a gas suction port, a gas suction channel, a blower device, a gas exhaust channel, and a gas guide port, wherein the gas suction port, the gas suction channel, the blower device, the gas exhaust channel and the gas guide port are sequentially communicated in tandem; the housing is provided with a stovetop and a fume collecting hood extending outwards, the fume collecting hood is located above the stovetop, and the stovetop is provided with a stove area; the gas suction port is provided on a lower surface of the fume collecting hood; and the gas guide port is arranged on the stovetop, and has a multi-hole structure with multiple holes, wherein the holes are provided around a periphery of the stove area, and all the holes are inclined toward a same clockwise or anti-clockwise direction and have a same inclined angle with respect to the stovetop.

The kitchen range with internal circulation oil fume purification further includes a purification device. The purification device is disposed at the gas suction port, inside the gas suction channel, or inside the gas exhaust channel.

The purification device includes a mechanical grease separation device. The mechanical grease separation device is disposed at the gas suction port, or inside the gas suction channel.

The purification device further includes one, or any combination, of an electrostatic oil fume purifier, a HEPA (high-efficiency particulate gas) filter, an activated carbon filter material, a photocatalyst filter, and an ultraviolet lamp.

The gas guide port is disposed obliquely.

The multi-hole structure is saw-toothed, with openings of the holes located on oblique tooth surfaces having the same inclined angle with respect to the stovetop.

As an alternative embodiment, the multi-hole structure has a wave shape, with openings of the holes located on oblique wave slopes having the same inclined angle with respect to the stovetop.

The kitchen range with internal circulation oil fume purification further includes an auxiliary blower disposed inside the fume collecting hood, wherein a gas suction direction of the auxiliary blower is directed towards the stove area through the gas suction port, and a rotational direction of the auxiliary blower is consistent with an oblique gas outflow direction of the gas guide port.

The kitchen range with internal circulation oil fume purification further includes a water-cooling device. The water-cooling device is disposed inside the housing.

In accordance with the kitchen range with internal circulation oil fume purification provided by the present disclosure, by providing the gas suction port opposite to the stove area of the stovetop and providing the gas guide port around the periphery of the stove area, the gas exhausted by the compression and exhausting of the blower device can entrain the oil fume gas to enter the same channel for recirculation together. The oil fume gas generated by cooking may be effectively prevented from escaping. Meanwhile, the airflow in the same circulating suction and exhaust channel mitigates the load of the blower device, and reduces the energy consumption for suction and exhaust.

The conception, specific structure and resulting technical effects of the present disclosure will be further described below with reference to the accompanying drawings in order to make the purpose, features and effects of the present disclosure understood fully.

### BRIEF DESCRIPTION OF THE DRAWINGS

FIG. 1 is a sectional view of a kitchen range with internal circulation oil fume purification in accordance with the present disclosure.

FIG. 2 is a schematic diagram of a kitchen range with internal circulation oil fume purification in accordance with the present disclosure.

FIG. 3 is a sectional view of a gas guide port arranged around a periphery of a stove area in accordance with the present disclosure.

### DETAILED DESCRIPTION OF VARIOUS EMBODIMENTS

The present disclosure is further described below with reference to the accompanying drawings.

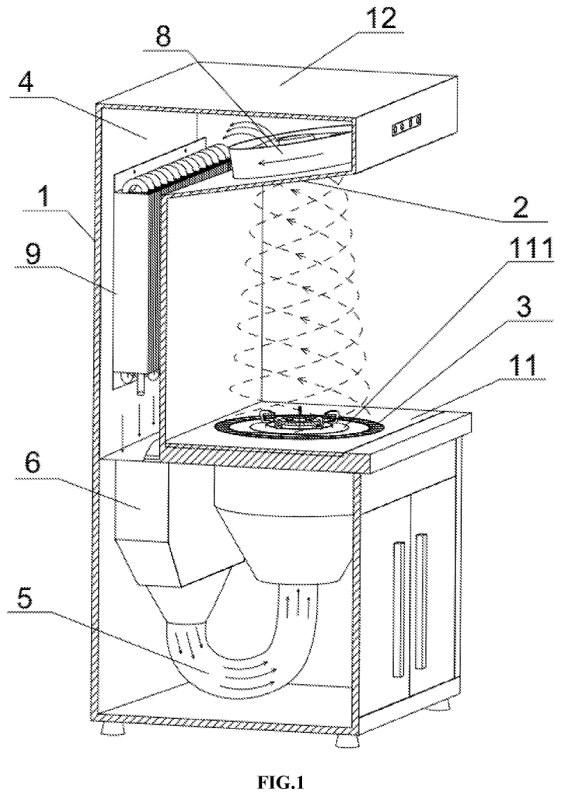

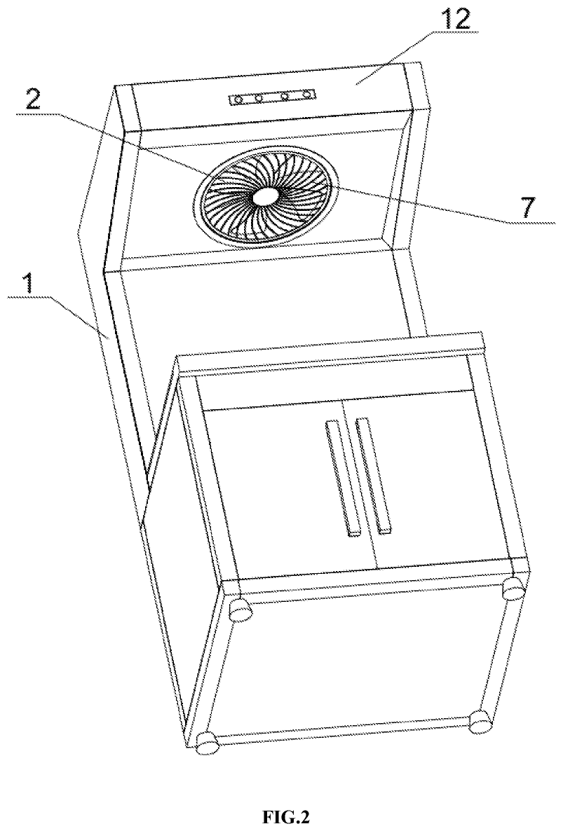

As shown in FIG. 1 and FIG. 2, a kitchen range with internal circulation oil fume purification includes a housing 1, a gas suction port 2, a gas guide port 3, a gas suction channel 4, a gas exhaust channel 5, and a blower device 6. The gas suction port 2, the gas suction channel 4, the blower device 6, the gas exhaust channel 5 and the gas guide port 3 are sequentially communicated in tandem. That is, after entering the gas suction port 2, oil fume gas passes through the gas suction channel 4, the blower device 6 and the gas exhaust channel 5 in sequence, and then exits from the gas guide port 3. During this process, the blower device 6 has a certain purification effect on the oil fume gas due to centrifugal action.

The housing 1 is provided with a stovetop 11 and a fume collecting hood 12 extending outwards. The fume collecting hood 12 is located above the stovetop 11. The stovetop 11 is provided with a stove area 111 for placing a stove, such as a gas stove, or an induction cooker.

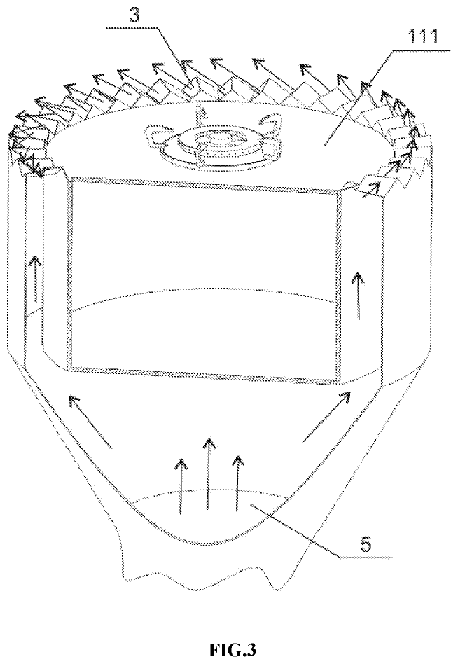

The gas suction port 2 is provided on the lower surface of the fume collecting hood 12. As shown in FIG. 3, the gas guide port 3 is provided on the stovetop 11. The gas guide port 3 has a multi-hole structure with multiple holes, wherein the holes are disposed around a periphery of the stove area 111, and all the holes are inclined toward a same clockwise or anti-clockwise direction and have a same inclined angle with respect to the stovetop 11, thus ensuring that the gas exhausted from the gas guide port 3 have the same direction without generating mutual airflow disturbance. When the kitchen range with internal circulation oil fume purification operates, the gas exhausted from the gas guide port 3 may entrain the oil fume gas produced by cooking in the center thereof to prevent the oil fume gas from escaping, and the oil fume gas is limited into an operation space above the stove area 111 to prevent the cooking personnel from being polluted. Meanwhile, under an action of suction from above, the gases exhausted from the gas guide port 3 entrain the oil fume gas to flow through the gas suction port 2 and enter the gas suction channel 4 together. In this way, not only the exhausted gas can return to the kitchen range with internal circulation oil fume purification for recirculation, but also the suction effect is improved, and the electric power load of the blower device 6 is reduced.

The gas guide port 3 is disposed obliquely, which is neither parallel nor vertical to the stovetop 11. For example, the multi-hole structure is saw-toothed, with openings of the holes on oblique tooth surfaces having the same inclined angle with respect to the stovetop; or the multi-hole structure presents a wave shape, with openings of the holes on the oblique wave slopes having the same inclined angle with respect to the stovetop. In this way, the gas exhausted from the gas guide port 3 forms a cyclonic flow like a tornado, which can prevent the oil fume gas from escaping more effectively and enhance the gathering and suction effect of the oil fume gas.

The kitchen range with internal circulation oil fume purification further includes a purification device 7. The purification device 7 is disposed at the gas suction port 2, inside the gas suction channel 4, or inside the gas exhaust channel 5, so as to perform further purification treatment on the oil fume gas.

The purification device 7 further includes a mechanical grease separation device. The mechanical grease separation device is arranged at the gas suction port 2 or in the gas suction channel 4 to avoid the grease from polluting components in the housing 1.

The purification device 7 further includes one, or any combination, of an electrostatic oil fume purifier, a HEPA filter, an activated carbon filter material, a photocatalyst filter, and an ultraviolet lamp (UV lamp). It is to be noted that when the purification device 7 employs various purification components or modules, different purification components or modules can be provided separately, e.g., partially arranged inside the gas suction channel 4, and partially arranged inside the gas exhaust channel 5.

The kitchen range with internal circulation oil fume purification further includes an auxiliary blower 8. The auxiliary blower 8 is disposed inside the fume collecting hood 12, wherein a gas suction direction of the auxiliary blower is directed towards the stove area 111 through the gas suction port 2, and a rotational direction of the auxiliary blower is consistent with an oblique gas outflow direction of the gas guide port 3, such that the suction generated by the auxiliary blower 8 can further improve the entrainment effect and the electric power load of the blower device 6 can be decreased.

The kitchen range with internal circulation oil fume purification further includes a water-cooling device 9. The water-cooling device 9 is arranged inside the housing 1 to effectively protect electric elements and reduce the temperature of the housing 1. Meanwhile, the indoor temperature is reduced, and hot water may also be available for a secondary use.

The preferred embodiments of the present disclosure have been described above in detail. It should be understood that those skilled in the art may make various modifications and changes according to the idea of the present disclosure without creative labor. Therefore, any technical solution that can be obtained by logical analysis, reasoning or limited experiments based on the prior art by those skilled in the art in accordance with the idea of the present disclosure shall fall within the scope defined by the claims.

What is claimed is:

1. A kitchen range with internal circulation oil fume purification, comprising a housing, a gas suction port, a gas suction channel, a blower device, a gas exhaust channel, and a gas guide port, wherein the gas suction port, the gas suction channel, the blower device, the gas exhaust channel and the gas guide port are sequentially communicated in tandem; the housing is provided with a stovetop and a fume collecting hood extending outwards, the fume collecting hood is located above the stovetop, and the stovetop is provided with a stove area; the gas suction port is provided on a lower surface of the fume collecting hood; and the gas guide port is arranged on the stovetop, and has a multi-hole structure with multiple holes, wherein the holes are provided around a periphery of the stove area, and all the holes are inclined toward a same clockwise or anti-clockwise direction and have a same inclined angle with respect to the stovetop.

2. The kitchen range with internal circulation oil fume purification according to claim 1, further comprising a purification device, wherein the purification device is disposed at the gas suction port, inside the gas suction channel or inside the gas exhaust channel.

3. The kitchen range with internal circulation oil fume purification according to claim 2, wherein the purification device comprises a mechanical grease separation device which is arranged at the gas suction port, or inside the gas suction channel.

4. The kitchen range with internal circulation oil fume purification according to claim 3, wherein the purification device further comprises one, or any combination, of an electrostatic oil fume purifier, a HEPA filter, an activated carbon filter material, a photocatalyst filter, and an ultraviolet lamp.

5. The kitchen range with internal circulation oil fume purification according to claim 1, wherein the gas guide port is disposed obliquely.

6. The kitchen range with internal circulation oil fume purification according to claim 5, wherein the multi-hole structure is saw-toothed, with openings of the holes located on oblique tooth surfaces having the same inclined angle with respect to the stovetop.

7. The kitchen range with internal circulation oil fume purification according to claim 5, wherein the multi-hole structure has a wave shape, with openings of the holes located on oblique wave slopes having the same inclined angle with respect to the stovetop.

8. The kitchen range with internal circulation oil fume purification according to claim 5, further comprising an auxiliary blower, disposed inside the fume collecting hood, wherein a gas suction direction of the auxiliary blower is directed towards the stove area through the gas suction port, and a rotational direction of the auxiliary blower is consistent with an oblique gas outflow direction of the gas guide port.

9. The kitchen range with internal circulation oil fume purification according to claim 1, further comprising a water-cooling device, wherein the water-cooling device is disposed inside the housing.
